(19) United States
(12) Patent Application Publication
(10) Pub. No.: US 2026/0183696 A1
(43) Pub. Date: Jul. 2, 2026

(54) MOF COATED CONTACTOR FOR CO2 CAPTURE

(71) Applicant: Mosaic Materials, Inc., Alameda, CA (US)

(72) Inventors: Marco Palladino, Calenzano (FI) (IT); David Madden, Limerick (IE); Alexander John Cruz, Mechelen (BE); Giulia Contran, Milano (MI) (IT); Chad Yates, Houston, TX (US)

(21) Appl. No.: 19/008,262

(22) Filed: Jan. 2, 2025

(51) Int. Cl. B01D 53/04; B01J 20/22

(52) U.S. Cl. CPC B01D 53/0438; B01J 20/226; B01D 2253/204; B01D 2253/25; B01D 2257/302; B01D 2257/404; B01D 2257/504; B01D 2258/0283; B01D 2259/40088

(57) ABSTRACT

A CO2 capture system includes a contactor having a sorbent-coated channel and a heat-transfer channel that contacts the sorbent-coated channel. The sorbent-coated channel has a substrate and a coating disposed on the substrate. The coating includes a metal-organic framework sorbent and a binder. The sorbent-coated channel has an irregular internal surface, or the sorbent-coated channel further includes an internal structure disposed in an internal space of the sorbent-coated channel, or a combination thereof.

### BACKGROUND

This disclosure is directed to sorbent coated contactors and the use thereof for CO₂ capture.

Carbon dioxide (CO₂) separation technology is a cyclic process. After a sorbent is saturated with CO₂, a desorption step is performed to regenerate the sorbent and to release the captured CO₂ for storage or further use.

Metal-organic framework (MOF) sorbents are widely used in cyclic processes for carbon capture. MOF sorbents are currently available as pellets to be used in packed bed configurations. These sorbents are normally regenerated by heating the loaded sorbents and is one of the main energy consumption sources for the application. Accordingly, there is a continuing need for CO₂ capture system and process that can provide an energy efficient sorbent regeneration and faster CO₂ desorption together with mechanical stability.

### SUMMARY

A CO2 capture system comprises a contactor having a sorbent-coated channel and a heat-transfer channel that contacts the sorbent-coated channel, the sorbent-coated channel having a substrate and a coating disposed on the substrate, the coating comprising a metal-organic framework sorbent and a binder, wherein the sorbent-coated channel has an irregular internal surface, or the sorbent-coated channel further comprises an internal structure disposed in an internal space of the sorbent-coated channel, or a combination thereof.

A method of removing CO2 from a flue gas comprises introducing a flue gas having a temperature of T2 to a heat-transfer channel in a CO₂ capture system, the CO₂ capture system further comprising a sorbent-coated channel that contacts the heat-transfer channel, the sorbent-coated channel having a substrate and a coating disposed on the substrate, and the coating comprising a metal-organic framework sorbent; transferring heat from the flue gas having a temperature of T2 in the heat-transfer channel to the coating in the sorbent-coated channel to release CO₂ adsorbed by the metal-organic framework sorbent in the coating, generating a CO₂ stream from the sorbent-coated channel, and a flue gas having a temperature of T3 which is less than T2 from the heat-transfer channel; introducing the flue gas having a temperature of T3 to a cooling device to produce a flue gas having a temperature of T4 which is less than T3; and introducing the flue gas having a temperature of T4 into the sorbent-coated channel in the CO₂ capture system or a second sorbent-coated channel in a second CO₂ capture system to remove at least a portion of CO₂ from the flue gas having a temperature of T4, generating a cleaned gas.

### BRIEF DESCRIPTION OF THE DRAWINGS

A description of the figures, which are meant to be exemplary and not limiting, is provided in which:

FIG. 1A is simplified scheme illustrating a CO₂ capture system having sorbent-coated channels and heat-transfer channels;

FIG. 1B is an axial view of a simplified scheme illustrating a CO₂ capture system having sorbent-coated channels and heat-transfer channels;

FIG. 1C is a perspective view of the CO₂ capture system of FIG. 1B;

FIG. 2A is a top view of an example of a sorbent-coated channel having an internal structure;

FIG. 2B is a top view of another example of a sorbent-coated channel having an internal structure with apertures;

FIG. 3 is a scheme illustrating a sorbent-coated channel having a two-layer coating;

FIG. 4A illustrates an adsorption process with coolant circulation;

FIG. 4B illustrates a desorption process with waste heat circulation; and

FIG. 5 illustrates a method of removing CO₂ from a CO₂-containing gas using a CO₂ capture system.

### DETAILED DESCRIPTION

A detailed description of one or more embodiments is presented herein by way of exemplification and not limitation.

The inventors hereof have found that a topology optimized contactor coated by MOF can provide excellent thermal transportation properties as well as mass transport via optimized fluid flow. In particular, the MOF coated and topology optimized contactor can be used in a CO₂ capture system to provide effective and a more homogeneous heat management system, thus speeding up the desorption phase. In addition, the contactor has a sorbent-coated channel and a heat-transfer channel that contacts the sorbent-coated channel, and the configuration allows the MOF sorbent in the coating to be heated by waste heat in the heat-transfer channel, thus avoiding directly heating the loaded MOF sorbent using flow like steam which can affect the MOF adsorption properties.

Moreover, the excellent thermal transportation properties allow the CO₂ capture system to transfer the sorption heat generated during the adsorption phase away from the MOF sorbent quickly enough to keep the MOF sorbent cool thus mitigating negative effects (e.g., stability, CO₂ loading, adiabatic adsorption conditions) that a high temperature can have on certain MOF sorbents, for example, amine-functionalized MOF sorbents.

Using a topology optimized metallic contactor coated by MOF can also improve the mechanical stability of the CO₂ capture system due to a reduction in mechanical attrition compared to pellets hitting and griding off each other. When using a substrate for support instead of compacted pellets, an interaction between the MOF and the substrate may be stronger compared to compaction of the pelletized structures.

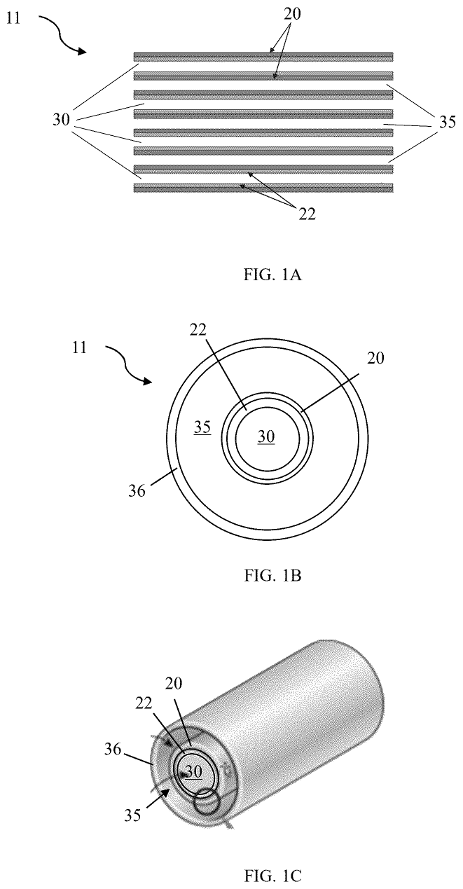

Referring to FIGS. 1A-1C, a CO₂ capture system (11) comprises a contactor having a sorbent-coated channel (30) and a heat-transfer channel (35) that contacts the sorbent-coated channel (30). The heat-transfer channel (35) may be formed within a cylindrical wall (36) as shown in FIGS. 1B and 1C. The sorbent-coated channel has a substrate (20) which forms a channel wall and a coating (22) disposed on the substrate (20). The substrate (20) may be a cylindrical structure as shown as FIGS. 1B and 1C, with coating (22) formed on an inner surface thereof defining the sorbent-coated channel (30). The CO₂ capture system can comprise more than one sorbent-coated channel and more than one heat-transfer channel. As shown in FIG. 1A, the system can include a plurality of the sorbent-coated channels and a plurality of the heat-transfer channels, and the sorbent-coated channels and the heat-transfer channels are arranged in an alternating manner. The heat-transfer channel is not coated with any sorbent, and the sorbent-coated channel and the heat-transfer channel shares a common channel wall. The common channel wall comprises a metal, a polymer, or a combination thereof.

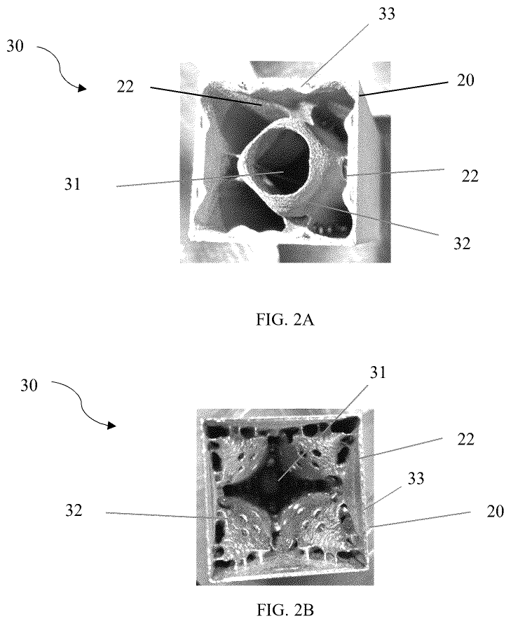

To optimize the heat transportation properties and mechanical stability of the system, the sorbent-coated channel (30) can have an irregular internal surface (33), and/or the sorbent-coated channel (30) can further comprise an internal structure (32) disposed in an internal space of the sorbent-coated channel (30) as illustrated in FIG. 2A and FIG. 2B. The internal structure (32) can have apertures. The internal structure (32) can also form an internal channel (31) within the sorbent-coated channel (30). Optionally, the internal structure (32) can also be coated with a coating containing a MOF sorbent and a binder as described herein.

The contactor with the optimized topology can be prepared via additive manufacturing using computer-aided design (CAD) software. The material for the additive manufacturing can include a metallic material, a polymeric material, or a combination thereof. Non-limiting examples of the polymeric material can include thermally conductive plastics such as COOLPOLY TCP available from Celanese, ICE9 available from TCPoly, and Ultra Diamond PLA available from Tiamet 3D.

The coating comprises a MOF sorbent and a binder as described herein. Preferably, the MOF sorbent is an amine functionalized MOF material. “Functionalized” means that the amine is coordinated to an open metal site of the MOF material.

The method of forming the coating is not limited. For example, the MOF sorbent can be mixed with the binder in a solvent forming a mixture, and the mixture can be applied to a channel with optimized topology via dip coating, spin coating, spray coating, vapor-phase coating, or a combination thereof, forming the coating. Suitable solvents are known and can include low boiling points solvents of polar and non-polar nature, alkanes, aromatics, and others including, but are not limited to acetone, acetonitrile, dimethylformamide (DMF), dimethylsulfoxide (DMSO), methanol, ethanol, isopropanol, and water.

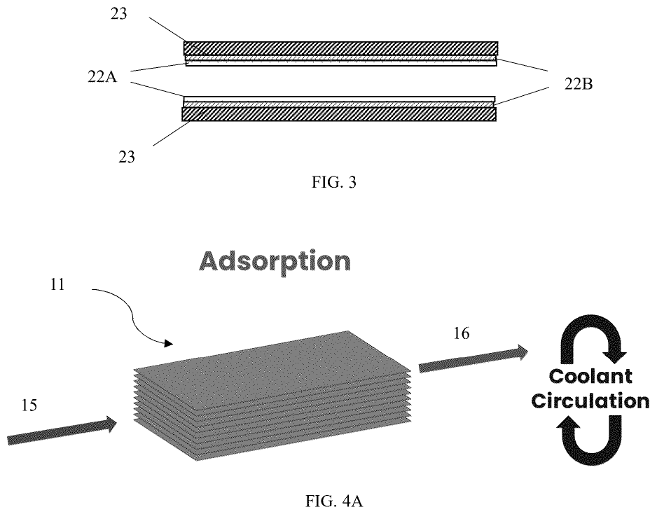

The coating can have more than one layers. Referring to FIG. 3, a coating can have a first layer (22A), and a second layer (22B) disposed between the first layer (22A) and a surface (23) of the substrate of the sorbent-coated channel. The first layer (22A) comprises at least a NOx sorbent and/or a SOx sorbent and/or a MOF sorbent, and the second layer (22B) comprises a MOF sorbent and a binder. NOx and SOx sorbents are known to a person skilled in the art. As a non-limiting example, commercially available elective catalytic reduction systems may be included in the first layer (22A). The first layer (22A) can also include a binder.

Amine functionalized MOF sorbents display exceptional CO₂ adsorption performance. However, their deployment for CO₂ capture can be limited by their stability in toxic gases. By including a first layer comprising at least a NOx sorbent or a SOx sorbent, the system and process disclosed herein ensure efficient CO₂ capture by amine functionalized MOF sorbents under challenging point-source flue gas conditions. In particular, the first coating layer can safeguard the MOF from degradation during adsorption cycles by removing the toxic gas in the CO2-containing gas to be treated before the toxic gas reaches the MOF in the second layer of the coating. Accordingly, the configuration can be improve the lifetime of MOF sorbents.

The CO₂ capture system as disclosed herein can be used to remove CO₂ from a CO₂-containing gas. The CO₂-containing gas stream entering the system can include air, natural gas, industrial effluents and commercial emissions. In an aspect, the CO₂-containing gas stream is a flue gas, which can be the gas produced when fossil fuels such as coal, oil, natural gas, or biomass (e.g., wood) are burned for heat or power.

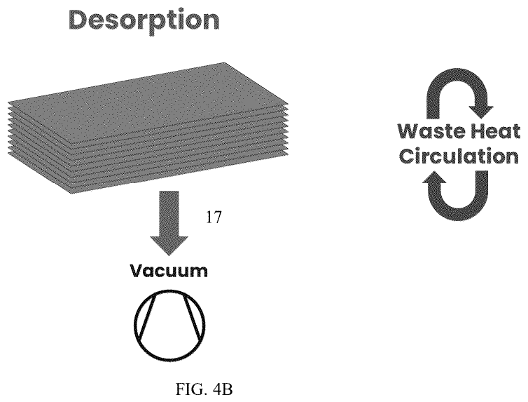

The method includes introducing the CO₂-containing gas (15) into the sorbent-coated channel; circulating a cooling medium in the heat-transfer channel to reduce a temperature of the CO₂-containing gas introduced into the sorbent-coated channel; and removing at least a portion of CO₂ from the CO₂-containing gas to generate a CO₂-lean gas stream (16) as illustrated in FIG. 4.

There are several ways to heat the loaded sorbents. Heating can be introduced through sorbent channels (30), introducing hot inert gas (e.g., nitrogen), hot steam into heat exchange channels (35), heating the substrate via conductive heating, induction heating, or microwave heating. Vacuum or reduced pressure can be applied throughout the process if needed. An example of the desorption method includes circulating a heating medium in the heat-transfer channel, or applying a vacuum or reduced pressure to the sorbent-coated channel, or a combination thereof; and generate a CO₂ stream from the sorbent-coated channel as illustrated in FIG. 4B.

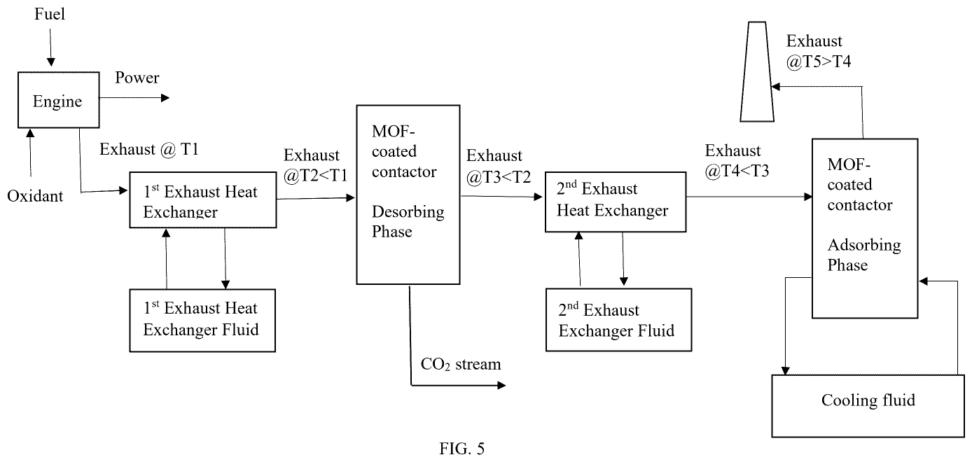

FIG. 5 illustrates a method of removing CO₂ from a flue gas using a CO₂ capture system. The method comprises: introducing a flue gas having a temperature of T2 to a heat-transfer channel in a CO₂ capture system as disclosed herein, transferring heat from the flue gas having a temperature of T2 in the heat-transfer channel to the coating in the sorbent-coated channel to release CO₂ (and, in some embodiments, NO_{X} and/or SO_{X}) adsorbed by the MOF sorbent in the coating, generating a CO₂ stream from the sorbent-coated channel, and a flue gas having a temperature of T3 which is less than T2 from the heat-transfer channel; introducing the flue gas having a temperature of T3 to a cooling device to produce a flue gas having a temperature of T4 which is less than T3; and introducing the flue gas having a temperature of T4 into the sorbent-coated channel in the CO₂ capture system or a second sorbent-coated channel in a second CO₂ capture system to remove at least a portion of CO₂ from the flue gas having a temperature of T4, generating a cleaned gas. The sorbent-coated channel in the CO₂ capture system or a second sorbent-coated channel in a second CO₂ capture system may be cooled by cooling fluid. The method can further include reducing a temperature (T1) of an exhaust gas from a power source to provide the flue gas having a temperature of T2.

As used herein, the MOF sorbent in the coating refers to a functionalized MOF material such as an amine functionalized MOF material, e.g., amines. The MOF material includes inorganic nodes connected by organic linkers. The inorganic nodes comprise metal sites, which can be ions of least one of Mg, Ca, Ba, Al, Sc, Zr, V, Cr, Mn, Fe, Co, Ni, Cu, Zn, Ti, Cd, or Eu, preferably the ions of at least one of Mg, Mn, Zn, or Ni. The organic linkers can comprise at least one of a carboxylate, a triazolate, or an imidazolate, preferably a carboxylate. Examples of the organic linkers include, but are not limited to, 4,4′-dihydroxy-(1,1′-biphenyl)-3,3′-dicarboxylate, 2,5-dihydroxybenzene-1,4-dicarboxylate, 4,6-dihydroxybenzene-1,3-dicarboxylate, benzene- 1,4-dicarboxylate, benzene-1,3,5-tricarboxylate, 3,3′,4,4′-benzophenone-tetracarboxylate, benzene-1,2,4,5-tetracarboxylate, trans-1,4-cyclohexanedicarboxylate, 1H,7H-[1,4]dioxino[2,3-F: 5,6-F′]bisbenzotriazolate, 1,5-dihydrobenzo[1,2-d:4,5-d′]bis([1,2,3]triazolate, 3,5-dimethyl-1H-pyrazole-4-carboxylate, 5-(pyridin-3-yl)benzene-1,3-dicarboxylate, 1,3,5-tri(1H-tetrazol-5-yl) benzene, 2-methylimidazolate, 2-ethylimidazolate, and 1-benzyl-1H-imidazolate. Other suitable known organic linkers can also be used. Preferably the organic linkers comprise 4,4′-dihydroxy-(1,1′-biphenyl)-3,3′-dicarboxylate.

Examples of the MOF materials can include, but are not limited to, MOF-74, MOF-274, HKUST-1, MIl-100, MIL-101, MOF-525, MOF-2, MOF-505, UiO-66, ZIF-9, and ZIF-67. Additional MOFs include but are not limited to those described in Chem. Soc. Rev. 2020, 49, 2751-2798. A preferred MOF is Mg₂(dobpdc) where the inorganic nodes comprise Mg ions and the organic linkers comprise 4,4′-dihydroxy-(1,1′-biphenyl)-3,3′-dicarboxylate (dobpdc).

The amine can be a monoamine; a diamine such as a primary/primary diamine, a primary/secondary diamine, a primary/tertiary diamine, and a secondary/secondary diamine; a polyamine such as a triamine, a tetramine, and an aminopolymer; or a bifunctional amine. The amines may include tetraamines, pentamines and polyamine species.

The monoamines can be monoalkylamines, dialkylamines, trialkylamines, monoarylamines, diarylamines, triarylamines, and mixed alkyl-aryl-amines. Examples of the monoamines include, but are not limited to, aniline, n-butylamine, n-pentylamine, n-hexylamine, diphenylamine, and triethylamine.

Examples of the diamines include, but are not limited to, ethylene diamine, 2,2-dimethyl-1,3-propanediamine, 1,3-diaminopentane, 2-methylpropane-1,2-diamine, N-ethylethylenediamine, N-isopropylethylenediamine, N-butylethylenediamine, N-pentylethylenediamine, N-hexylethylenediamine, N,N-dimethylethane-1,2-diamine, N,N-diethylethylenediamine, N,N-diisopropylethylene diamine, N,N-dimethylpropylenediamine, N,N′-dimethylethane-1,2-diamine, 2-(aminomethyl)piperidine, N,N-diethyl-N-methylethylenediamine and N,N′-dimethylethylene diamine.

Suitable polyamines include, but are not limited to, bis(3-aminopropyl)amine, N,N′-bis(3-aminopropyl)-1,4-butanediamine, tetraethylene pentaamine, polyethyleneimine, and polypropyleneimine. Preferably, the amine includes a primary/secondary diamine disclosed herein.

As used herein, a bifunctional amine refers to an amine having an additional functional group other than an amino group. Examples of the bifunctional amines include, but are not limited to, amino-alcohols (also known as alkanolamines).

The binder in the coating can comprise at least one of a cellulose polymer, starch, a siloxane polymer, a cellulose-siloxane polymer, polyvinyl pyrrolidone, polyvinyl alcohol, poly (ethyl vinyl acetate), polyacrylate, polymethacrylate, polyvinylpyrrolidone, polyisobutene, a polyurethane, alumina, silica, zirconia, titania, alkoxysilanes, clays, an oxide of magnesium and of beryllium, a biopolymer, or crosslinked polymers.

The cellulose polymer can comprise at least one of methyl cellulose, amino methyl cellulose, hydroxyl methyl cellulose, hydroxyethyl methylcellulose, ethylhydroxy ethylcellulose, hydroxy propyl cellulose, hydroxyl propyl methylcellulose, carboxymethylcellulose, other cellulosic polymers, starches, or other natural gums. The siloxane polymer can comprise poly (hydroxymethyl) siloxane. Examples of the cellulose-siloxane polymer include cellulose methyl siloxane, cellulose amino methyl siloxane, or a combination thereof. Examples of the clay include silica-alumina clays, montmorillonites, kaolins, bentonites, halloysites, dickites, nacrites, anauxites, and attapulgite.

As a non-limiting example, the inventors hereof found that heat generated from CO₂ capture in direct air capture (which, for example, may have around 400 ppm CO₂) may raise a temperature of the packed sorbent bed by, e.g., 10° C. In CO₂ capture from flue gas (which, for example, may have around 50,000 ppm CO₂), heat generated is much greater and may raise the temperature of the packed sorbent bed by as much as, e.g., 60° C. Such increases may result in simultaneous adsorption and desorption of CO₂ in the packed sorbent bed. This can reduce the MOF CO₂ working capacity significantly, e.g., by over 70%. Using a heat exchanger during the adsorption cycle in accordance to one or more embodiments may an maintain isothermal adsorption conditions and maintain performance of the MOF during CO₂ capture.

While CO₂ capture systems and methods of removing CO₂ from a CO₂-containing gas are discussed above with respect to MOF sorbents, the present disclosure is not limited thereto. For example, one or more of the CO₂ capture systems and methods of removing CO₂ from a CO₂-containing gas may be used with other solid sorbents that display a high isosteric heat of adsorption (ΔH_{ads} or Qₛₜ). An increase in ΔH_{ads} may correspond to an increase in an exothermic amount of the CO₂ adsorption process. Sorbents having high ΔH_{ads} may undergo runaway heating during the capture process in a packed bed setup, causing a heat block and adiabatic adsorption conditions, which may be detrimental to the CO₂ capture systems and methods of removing CO₂ from a CO₂-containing gas. One or more of the of the CO₂ capture systems and methods of removing CO₂ from a CO₂-containing gas described above may be applicable to any sorbent with ΔH_{ads} above 45 kJ/mol.

Set forth are various methods/apparatus of the disclosure.

Embodiment 1: A CO₂ capture system including a contactor having a sorbent-coated channel and a heat-transfer channel that contacts the sorbent-coated channel, the sorbent-coated channel having a substrate and a coating disposed on the substrate, the coating comprising a metal-organic framework sorbent and a binder, wherein the sorbent-coated channel has an irregular internal surface, or the sorbent-coated channel further comprises an internal structure disposed in an internal space of the sorbent-coated channel, or a combination thereof.

Embodiment 2: The CO₂ capture system as in any prior embodiment, wherein the CO₂ capture system comprises a plurality of the sorbent-coated channels and a plurality of the heat-transfer channels, and the sorbent-coated channels and the heat-transfer channels are arranged in an alternating manner.

Embodiment 3: The CO₂ capture system as in any prior embodiment, wherein the sorbent-coated channel has the irregular internal surface.

Embodiment 4: The CO₂ capture system as in any prior embodiment, wherein the sorbent-coated channel further comprises the internal structure disposed in the internal space of the sorbent-coated channel.

Embodiment 5: The CO₂ capture system as in any prior embodiment, wherein the internal structure forms an internal channel within the sorbent-coated channel.

Embodiment 6: The CO₂ capture system as in any prior embodiment, wherein the internal structure has apertures.

Embodiment 7: The CO₂ capture system as in any prior embodiment, wherein the coating has a first layer, and a second layer disposed between the first layer and the substrate of the sorbent-coated channel, the first layer comprising at least a NOx sorbent or a SOx sorbent, and the second layer comprising the metal-organic framework sorbent.

Embodiment 8: The CO₂ capture system as in any prior embodiment, wherein the metal-organic network sorbent is a functionalized metal-organic network material.

Embodiment 9: The CO₂ capture system as in any prior embodiment, wherein the heat-transfer channel is not coated with any sorbent, and the sorbent-coated channel and the heat-transfer channel shares a common channel wall.

Embodiment 10: The CO₂ capture system as in any prior embodiment, wherein the common channel wall comprises a metal or a polymer.

Embodiment 11: A method of removing CO₂ from a CO₂-containing gas with the CO₂ capture system as in any prior embodiment, the method including introducing the CO₂-containing gas into the sorbent-coated channel, circulating a cooling medium in the heat-transfer channel to reduce a temperature of the CO₂-containing gas introduced into the sorbent-coated channel, and removing at least a portion of CO₂ from the CO₂-containing gas to generate a cleaned gas stream.

Embodiment 12: The method as in any prior embodiment, wherein the method further includes circulating a heating medium in the heat-transfer channel, and/or applying a reduced pressure to the sorbent-coated channel, or a combination thereof, and generate a CO₂ stream from the sorbent-coated channel.

Embodiment 13: A method of removing CO₂ from a flue gas, the method including introducing a flue gas having a temperature of T2 to a heat-transfer channel in a CO₂ capture system, the CO₂ capture system further comprising a sorbent-coated channel that contacts the heat-transfer channel, the sorbent-coated channel having a substrate and a coating disposed on the substrate, and the coating comprising a metal-organic framework sorbent, transferring heat from the flue gas having a temperature of T2 in the heat-transfer channel to the coating in the sorbent-coated channel to release CO₂ adsorbed by the metal-organic framework sorbent in the coating, generating a CO₂ stream from the sorbent-coated channel, and a flue gas having a temperature of T3 which is less than T2 from the heat-transfer channel, introducing the flue gas having a temperature of T3 to a cooling device to produce a flue gas having a temperature of T4 which is less than T3, and introducing the flue gas having a temperature of T4 into the sorbent-coated channel in the CO₂ capture system or a second sorbent-coated channel in a second CO₂ capture system to remove at least a portion of CO₂ from the flue gas having a temperature of T4, generating a cleaned gas.

Embodiment 14: The method as in any prior embodiment, wherein generating the CO₂ gas further comprises applying a reduced pressure to the sorbent-coated channel.

Embodiment 15: The method as in any prior embodiment, further comprising reducing a temperature of an exhaust gas from a power source to provide the flue gas having a temperature of T2.

Embodiment 16: The method as in any prior embodiment, wherein the sorbent-coated channel has an irregular internal surface.

Embodiment 17: The method as in any prior embodiment, wherein the sorbent-coated channel further comprises an internal structure disposed in an internal space of the sorbent-coated channel.

Embodiment 18: The method as in any prior embodiment, wherein the internal structure forms an internal channel within the sorbent-coated channel.

Embodiment 19: The method as in any prior embodiment, wherein the internal structure has apertures.

Embodiment 20: The method as in any prior embodiment, wherein the coating has a first layer, and a second layer disposed between the first layer and the substrate of the sorbent-coated channel, the first layer comprising at least a NOx sorbent or a SOx sorbent, and the second layer comprising the metal-organic framework material.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

Unless defined otherwise, technical and scientific terms used herein have the same meaning as is commonly understood by one of skill in the art to which this invention belongs.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A CO₂ capture system comprising:
a contactor having a sorbent-coated channel and a heat-transfer channel that contacts the sorbent-coated channel, the sorbent-coated channel having a substrate and a coating disposed on the substrate, the coating comprising a metal-organic framework sorbent and a binder, wherein the sorbent-coated channel has an irregular internal surface, or the sorbent-coated channel further comprises an internal structure disposed in an internal space of the sorbent-coated channel, or a combination thereof.

2. The CO₂ capture system of claim 1, wherein the CO₂ capture system comprises a plurality of the sorbent-coated channels and a plurality of the heat-transfer channels, and the sorbent-coated channels and the heat-transfer channels are arranged in an alternating manner.

3. The CO₂ capture system of claim 1, wherein the sorbent-coated channel has the irregular internal surface.

4. The CO₂ capture system of claim 1, wherein the sorbent-coated channel further comprises the internal structure disposed in the internal space of the sorbent-coated channel.

5. The CO₂ capture system of claim 4, wherein the internal structure forms an internal channel within the sorbent-coated channel.

6. The CO₂ capture system of claim 4, wherein the internal structure has apertures.

7. The CO₂ capture system of claim 1, wherein the coating has a first layer, and a second layer disposed between the first layer and the substrate of the sorbent-coated channel, the first layer comprising at least a NOx sorbent or a SOx sorbent, and the second layer comprising the metal-organic framework sorbent.

8. The CO₂ capture system of claim 1, wherein the metal-organic network sorbent is a functionalized metal-organic network material.

9. The CO₂ capture system of claim 1, wherein the heat-transfer channel is not coated with any sorbent, and the sorbent-coated channel and the heat-transfer channel shares a common channel wall.

10. The CO₂ capture system of claim 9, wherein the common channel wall comprises a metal or a polymer.

11. A method of removing CO₂ from a CO₂-containing gas with the CO₂ capture system of claim 1, the method comprising:
introducing the CO₂-containing gas into the sorbent-coated channel;
circulating a cooling medium in the heat-transfer channel to reduce a temperature of the CO₂-containing gas introduced into the sorbent-coated channel; and
removing at least a portion of CO₂ from the CO₂-containing gas to generate a cleaned gas stream.

12. The method of claim 11, wherein the method further comprises
circulating a heating medium in the heat-transfer channel, and/or applying a reduced pressure to the sorbent-coated channel, or a combination thereof; and
generate a CO₂ stream from the sorbent-coated channel.

13. A method of removing CO₂ from a flue gas, the method comprising:
introducing a flue gas having a temperature of T2 to a heat-transfer channel in a CO₂ capture system, the CO₂ capture system further comprising a sorbent-coated channel that contacts the heat-transfer channel, the sorbent-coated channel having a substrate and a coating disposed on the substrate, and the coating comprising a metal-organic framework sorbent;
transferring heat from the flue gas having a temperature of T2 in the heat-transfer channel to the coating in the sorbent-coated channel to release CO₂ adsorbed by the metal-organic framework sorbent in the coating, generating a CO₂ stream from the sorbent-coated channel, and a flue gas having a temperature of T3 which is less than T2 from the heat-transfer channel;
introducing the flue gas having a temperature of T3 to a cooling device to produce a flue gas having a temperature of T4 which is less than T3; and
introducing the flue gas having a temperature of T4 into the sorbent-coated channel in the CO₂ capture system or a second sorbent-coated channel in a second CO₂ capture system to remove at least a portion of CO₂ from the flue gas having a temperature of T4, generating a cleaned gas.

14. The method of claim 13, wherein generating the CO₂ gas further comprises applying a reduced pressure to the sorbent-coated channel.

15. The method of claim 13, further comprising reducing a temperature of an exhaust gas from a power source to provide the flue gas having a temperature of T2.

16. The method of claim 13, wherein the sorbent-coated channel has an irregular internal surface.

17. The method of claim 13, wherein the sorbent-coated channel further comprises an internal structure disposed in an internal space of the sorbent-coated channel.

18. The method of claim 17, wherein the internal structure forms an internal channel within the sorbent-coated channel.

19. The method of claim 18, wherein the internal structure has apertures.

20. The method of claim 13, wherein the coating has a first layer, and a second layer disposed between the first layer and the substrate of the sorbent-coated channel, the first layer comprising at least a NOx sorbent or a SOx sorbent, and the second layer comprising the metal-organic framework material.
